(19) United States
(12) Patent Application Publication
(10) Pub. No.: US 2026/0359078 A1
(43) Pub. Date: Nov. 12, 2026

(54) HIERARCHICAL POST FEED MANAGEMENT

(71) Applicant: Notion Labs, Inc., San Francisco, CA (US)

(72) Inventors: Annie Yu, San Francisco, CA (US); John Thomas Ryan, III, San Francisco, CA (US); Alex Gerstein, San Francisco, CA (US); Jonathan Yang, Brooklyn, NY (US)

(21) Appl. No.: 19/238,143

(22) Filed: Jun. 13, 2025

Related U.S. Application Data
(60) Provisional application No. 63/802,303, filed on May 8, 2025.

(51) Int. Cl. G06F 9/451; G06Q 10/10

(52) U.S. Cl. CPC G06F 9/451; G06Q 10/103

(57) ABSTRACT

The system creates a hierarchical post feed including a page post feed associated with a page, a teamspace post feed associated with a teamspace, and a home post feed. The page post feed includes multiple posts associated with the page including a particular post that includes a change to the page. The teamspace includes multiple pages including the page. The teamspace post feed includes multiple posts associated with the multiple pages. The home post feed includes multiple teamspace post feeds including the teamspace post feed. The system obtains an indication that the change to the page occurred and includes the particular post in the teamspace post feed. The particular post includes an identification of the change. Including the particular post in the teamspace post feed includes the particular post in the home post feed.

### CROSS-REFERENCE TO RELATED APPLICATIONS

This application claims the benefit of U.S. Provisional Patent Application Ser. No. 63/802,303, filed May 8, 2025, which is incorporated by reference herein in its entirety.

### BACKGROUND

Collaborative work platforms have emerged as integral tools in modern organizations, facilitating teamwork and communication across distributed workforces. These digital environments provide a centralized space for employees to share information, coordinate tasks, and collaborate on projects in real time. As businesses increasingly adopt remote and hybrid work models, collaborative platforms play a crucial role in maintaining productivity, fostering innovation, and enabling seamless cooperation among team members regardless of their physical location. Common features of collaborative work platforms include document sharing, task management, instant messaging, video conferencing, and integration with other productivity tools. These platforms aim to streamline workflows, reduce email overload, and create a unified workspace for teams to interact and accomplish shared objectives.

### BRIEF DESCRIPTION OF THE DRAWINGS

Reference will now be made, by way of example, to the accompanying drawings, which show example embodiments of the present application and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is a block diagram illustrating a hierarchical organization for managing post feeds.

FIG. 5 is a flowchart illustrating an embodiment of the hierarchical organization for managing post feeds of FIG. 4.

FIG. 6 is a flowchart of a method to hierarchically organize post feeds.

FIG. 7 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for management of a hierarchical post feed to distribute information to a user. Collaborative work platforms (e.g., Notion or Microsoft Office) allow teams to work together on the platform. However, many platforms do not allow an individual team member to easily broadcast recent work the individual team member has completed to the rest of the team. Often, work done by an individual is fragmented across a variety of documents and even a variety of teams. Accordingly, many workplaces use tools like email or Slack that are external to their collaborative work platforms to keep teams up to date. The present technology introduces a hierarchical post feed management system to broadcast information (e.g., recent work completed by an individual team member) to relevant teams and team members on a collaborative work platform.

In one aspect of the technology, a system can create a hierarchical post feed that includes a page post feed associated with a page, a teamspace post feed associated with a teamspace, and a home post feed associated with a home. The page post feed includes multiple posts associated with the page including a particular post. The particular post can include a change to the page. The teamspace includes multiple pages including the page, and the teamspace post feed includes multiple posts associated with the multiple pages. The home includes multiple teamspaces including the teamspace, and the home post feed includes multiple teamspace post feeds including the teamspace post feed. The system can obtain an indication that the change to the page occurred and then include the particular post in the teamspace post feed. The particular post can include an identification of the change and can be presented as a tile in the teamspace post feed.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

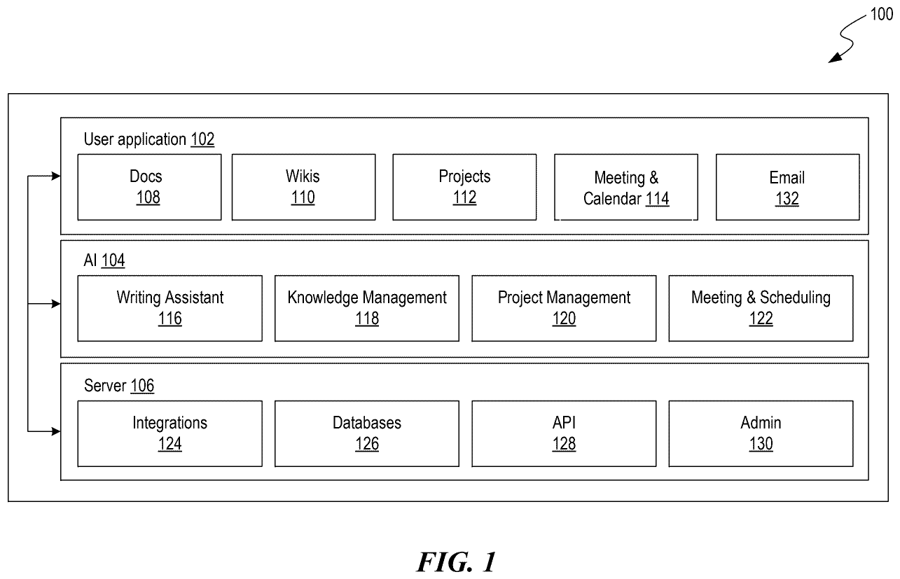

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

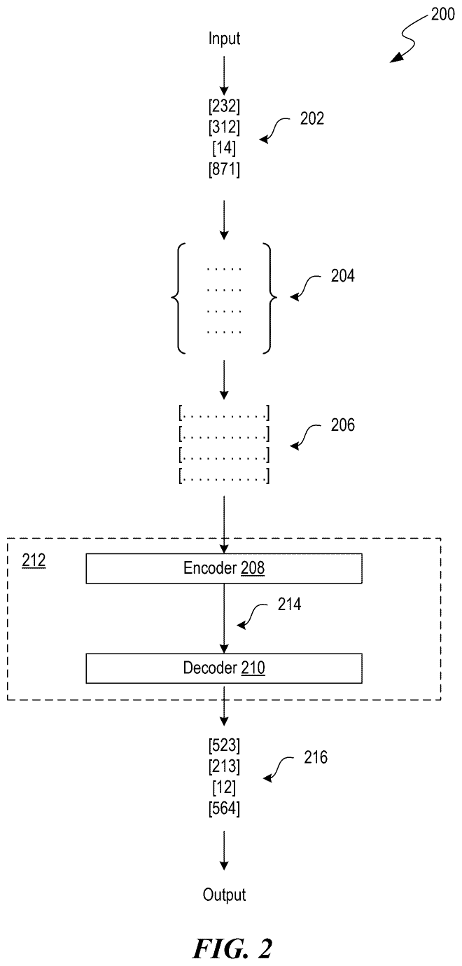

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

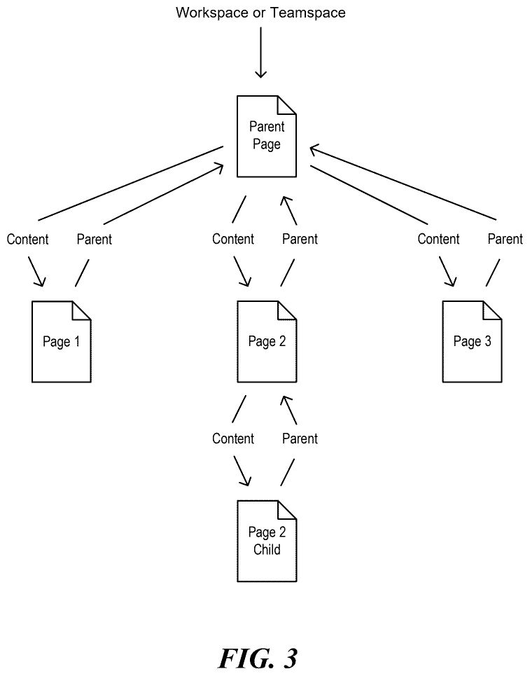

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

As described above with respect to FIG. 3, a teamspace (e.g., teamspace 1 404) can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces. A teamspace can include multiple pages.

A page is located hierarchically below a teamspace. A page can include blocks such as tabs, lists, images, tables, etc. as well as distinct sub-pages. Further, a page can be a database or the page can include an inline database as a block. Databases, as described above, can be a collection of pages.

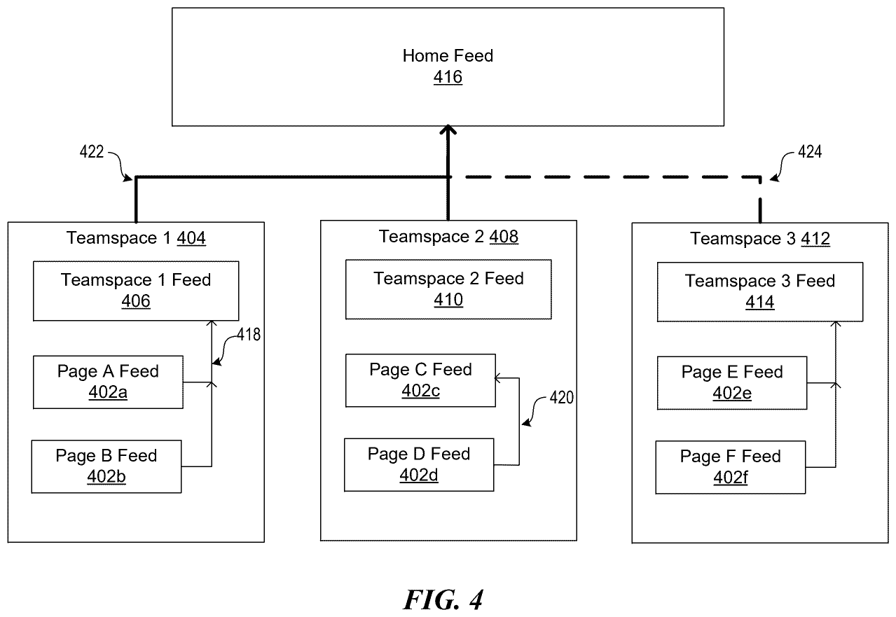

FIG. 4 is a block diagram illustrating a hierarchical organization for managing post feeds. As shown, the hierarchical organization includes (1) multiple page feeds (page A feed 402a, page B feed 402b, page C feed 402c, page D feed 402d, page E feed 402e, and page F feed 402f) referred to collectively herein as “page feeds 402,” (2) three teamspaces (teamspace 1 404, teamspace 2 408, and teamspace 3 412) and their corresponding teamspace feeds (teamspace 1 feed 406, teamspace 2 feed 410, and teamspace 3 feed 414), and (3) a home feed 416. The page feeds 402 are nested within a corresponding teamspace, and the teamspaces transmit posts to the home feed 416. A feed (e.g., page A feed 402a, teamspace 2 feed 410, and home feed 416) is a type of database that collects posts. A post, as described below, is a page entry to a feed database.

Regarding the page feeds 402, each page feed corresponds to a page positioned hierarchically below a teamspace. For example, page A feed 402a is a page feed corresponding to page A (not shown) positioned hierarchically below teamspace 1 404. The corresponding page can be positioned at any level below a teamspace. Accordingly, the corresponding page can be a page nested as a child page multiple levels below the teamspace.

In some embodiments, the page feeds 402 can be sub-page (i.e., child) databases positioned hierarchically below their respective pages (e.g., page A feed 402a can be a sub-page database corresponding to page A). In other embodiments, the page feeds 402 can be inline databases constructed as a block of their respective pages (e.g., page A feed 402a is an inline database block of page A).

The page feeds 402 can each be databases that collect posts related to their corresponding page positioned hierarchically below a teamspace. For example, page A feed 402a is a database of posts that relate to page A (not shown). In some embodiments, a post to a page feed (e.g., page A feed 402a) can be made manually. For example, a user can navigate to page A feed 402a of teamspace 1 404 and insert a post to the page feed database indicating that the sales figures represented in the corresponding page A will be updated the next day. In other embodiments, a post to a page feed can be made automatically. For example, the present technology can detect edits by a user to page A and then automatically generate a post for page A feed 402a indicating the edits to page A.

As shown in FIG. 4 via lines 418 and 420, the posts of page feeds 402 can be sent, or cross posted, from a page feed to a corresponding teamspace feed or from one page feed to another page feed. In some embodiments, posts to a page feed (e.g., page A feed 402a) are automatically cross posted to a corresponding teamspace feed (e.g., teamspace 1 feed 406). In other embodiments, posts to a page feed (e.g., page A feed 402a) will not be cross posted to a corresponding teamspace unless a user initiates the cross post. Similarly, a page feed (e.g., page D feed 402d) can require a user to initiate a cross post to send a post to the page feed to another page feed or the page feed (e.g., page D feed 402d) can be linked to another page feed (e.g., page C feed 402c) such that posts to the page feed are automatically cross posted to the other page feed. In yet further embodiments, the posts of page feeds 402 can be cross posted to any teamspace feed (i.e., teamspace 1 feed 406, teamspace 2 feed 410, teamspace 3 feed 414) or any of the page feeds 402.

Similar to the page feeds 402, the teamspace feeds (i.e., teamspace 1 feed 406, teamspace 2 feed 410, teamspace 3 feed 414) can each be databases that collect posts related to their corresponding teamspace feeds. Each teamspace feed corresponds to a single teamspace. For example, teamspace 1 feed 406 corresponds to teamspace 1 404. Additionally, the teamspace feeds are hierarchically positioned at the same level as the teamspace. Accordingly, the teamspace feeds can be inline databases configured as blocks of their respective teamspaces. For example, teamspace 1 feed 406 can be an inline database block of teamspace 1 404.

In some embodiments, a post to a teamspace feed (e.g., teamspace 1 feed 406) can be made manually. For example, a user can navigate to the teamspace 1 feed 406 of teamspace 1 404 and insert a post indicating that all pages within teamspace 1will be edited by a particular team member the next day. In other embodiments, a post to a page feed can be made automatically. For example, the present technology can detect edits by a user to a page nested within teamspace 1 404 and then automatically generate a post for teamspace 1 feed 406 indicating the edits to the nested page.

The home feed 416 can be a personalized feed for a particular user. Accordingly, the home feed 416 can be a database hierarchically positioned above the teamspaces associated with a particular user that collects posts from the teamspaces and page feeds 402 relevant to the particular user. The home feed 416 can be a portion of a home specific to the particular user within the collaborative work platform.

To create the personalized feed for a particular user, the home feed 416 can automatically collect all posts made to a teamspace feed of which the particular user is a member. The solid line 422 of FIG. 4 from teamspace 1 404 and teamspace 2 408 represents posts from teamspace 1 feed 406 and teamspace 2 feed 410, respectively, being automatically pulled into the home feed 416. Thus, as shown in FIG. 4, the particular user associated with the home feed 416 is a member of both teamspace 1 404 and teamspace 2 408. Membership refers to the particular user's access to a teamspace. For example, a member of teamspace 1 404 can enter the teamspace and edit one or more pages of teamspace 1 404. On the other hand, a user that is not a member of teamspace 1 404 cannot enter the teamspace and cannot edit one or more pages of teamspace 1 404. If the particular user is not a member of a teamspace, the particular user can still receive posts from the feed of the teamspace to the home feed 416 by opting in. The dotted line 424 represents the particular user, who is not a member of teamspace 3 412, opting in to receive the posts from teamspace 3 feed 414 at the home feed 416.

In embodiments where the posts of the page feeds 402 are not automatically included in their respective teamspace feeds, the particular user can receive the posts from one or more of the page feeds 402 at the home feed 416. In such embodiments, if the particular user is a member of the teamspace and subscribed to a page feed, the posts from that page feed will automatically be sent to the home feed 416. For example, if the particular user is a member of teamspace 1 404 and chooses to subscribe to page A feed 402a, the posts of page A feed 402a can be sent to the home feed 416. In the disclosed technology, a user can select which page feeds nested within a teamspace they are a member of to subscribe to or unsubscribe from.

The feeds described above (the home feed 416, the teamspace feeds, and the page feeds 402) can present the posts in reverse chronological order. In some embodiments, the reverse chronological order can be based on a time the posts within the feed were made. For example, a new post made to page A feed 402a can be presented first in page A feed 402a, with each subsequent post in the feed having been created prior to the post before it. As another example, the home feed, regardless of which teamspace feed or page feed the posts were originally entered to, can present its posts in reverse chronological order such that the most recent post made across all teamspaces of which the particular user is a member (or has opted in) will be presented first and the oldest post made across all teamspaces of which the particular user is a member (or has opted in) will be presented last.

In some embodiments, the posts in the feeds described above are presented as a tile. When presented as a tile, the post includes only a portion of the entire post inserted into the feed database. For example, a user can make a change to a page for which a post can be automatically generated and entered into the page feed of that page. However, the tile presented for that post in the page feed can show only the portion of the page that was changed by the user. In another example, the portion of the entire post shown by the tile can be just a title of the post or an AI-generated summary of the post. In other embodiments, the tile can be configured such that, when selected by a user viewing the tile, the tile can expand to show the entire post. Additionally, in yet further embodiments, the tile can include an embedded link that, when clicked, transfers the user to the original post. For example, when a post to a teamspace feed is automatically sent to the home feed 416, the tile of the post in the home feed 416 can include an embedded link that, when clicked by the particular user, transfers the user to the teamspace feed itself.

In some embodiments, when a post, or a page corresponding to a post, has been edited after the post is entered into one of the feeds described above, an indication of editing can be added by the system to the post in the feed. In other embodiments, a user can be mentioned within a post (e.g., by an “@ mention”). In such embodiments, a user can receive a notification of the mention via email, via a collaborative work platform including the hierarchical post feed management of FIG. 4, or via a highlighted post within the home feed 416.

The home feed 416 can use an artificial intelligence (for example, an artificial intelligence as described with respect to FIG. 2) to enhance the posts received by the teamspaces and the page feeds 402. In some embodiments, before a post is entered into the home feed 416, the home feed inputs the post to an artificial intelligence trained to summarize posts. Then, the summarized post is entered into the home feed 416 instead of the original post. For example, a long post to teamspace 1 feed 406 can be automatically pulled to the artificial intelligence, which can summarize the post into three or four sentences and enter those three or four sentences into the home feed 416. Such a summary can be the portion of the post presented as tile.

In an additional embodiment, the artificial intelligence of the home feed 416 can be configured to determine a frequency with which the particular user associated with the home feed 416 has viewed a post. In response to the particular user viewing a certain post more frequently than other posts, the artificial intelligence can reorder the home feed 416 such that the certain post is presented before less viewed posts. Further, in response to the particular user frequently viewing a certain post that is not included in the home feed 416, the artificial intelligence can pull the certain post from its respective teamspace feed or page feed and insert it into the home feed 416.

In another embodiment, the artificial intelligence of the home feed 416 can be configured to pull posts across all accessible teamspaces and page feeds 402 that relate to a particular topic. These posts can be entered into the artificial intelligence, which can then generate a digest of the topic and enter said digest to the home feed. For example, the particular user of home feed 416 may be interested in accounting practices across an organization. That organization, however, may have a variety of teams that use a variety of teamspaces that employ differing accounting practices. The artificial intelligence can pull all posts related to accounting practices across the organization and generate a breakdown of these practices as a post in the home feed 416. The artificial intelligence can be configured to pull posts related to a topic (e.g., accounting) over a set period of time (e.g., monthly, weekly) and generate a digest as a post in the home feed 416 that summarizes all updates to that topic created throughout the organization during that set period of time.

In yet another embodiment, the artificial intelligence of the home feed 416 can be configured to monitor posts viewed by an additional user. The artificial intelligence can compare the posts viewed by an additional user to the particular user associated with home feed 416 and, if the viewed posts are similar, identify which posts the additional user viewed that the particular user has not. Then, the artificial intelligence can insert the posts not viewed by the particular user into the home feed 416. For example, two users may be new to a job and reviewing posts related to new hire training. If the first user has viewed more new hire training posts than the second, the second user's home feed can recognize the disparity and include the unviewed posts to ensure the second user has not missed relevant training materials.

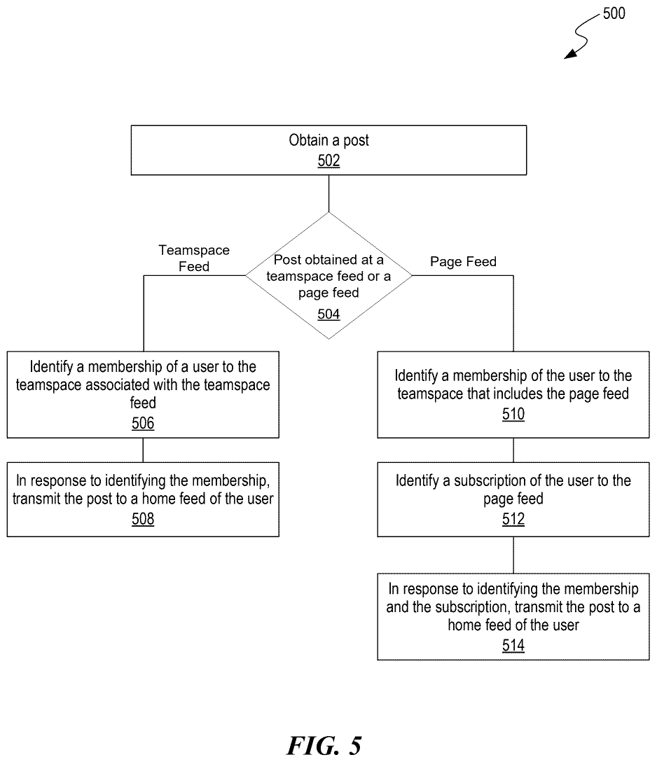

FIG. 5 is a flowchart illustrating an embodiment 500 of the hierarchical organization for managing post feeds of FIG. 4. At 502, a system obtains a post. A post can be a page entry made to the database of a teamspace feed or a page feed. Such an entry can be made automatically (e.g., automatically generated by the system after detecting a change to a page) or manually (e.g., made by a team member to notify a team of an update to a page). At 504, the system determines whether the post was obtained at a teamspace feed or a page feed. For example, in the case of a hierarchical structure as shown in FIG. 4, the system can determine whether a post was entered into a page feed like page A feed 402a or a teamspace feed like teamspace 1 feed 406.

If the post was obtained at a teamspace feed, at 506, the system can identify a membership of a user to the teamspace associated with the teamspace feed. Membership refers to the user's access to a teamspace. For example, a member of teamspace 1 404 of FIG. 4 can enter the teamspace and edit one or more pages of teamspace 1 404. At 508, in response to identifying the membership of the user to the teamspace associated with the teamspace feed where the post was obtained, the system can transmit the post to a home feed of the user. The home feed can be a personalized feed for the user that collects posts from teamspaces and page feeds relevant to the user. The home feed can be a portion of a home of the user within the collaborative work platform (e.g., a feed accessible through a user's home page on the collaborative work platform).

If the post was obtained at a page feed, at 510, the system can identify a membership of a user to the teamspace that includes the page feed. Then, at 512, the system can identify a subscription of the user to the page feed. Subscribing to a page feed can indicate to the system that the user wishes to have posts made to the page feed included in the user's home feed. At 514, in response to identifying the membership to the teamspace and the subscription to the page feed, the system can transmit the post to the user's home feed.

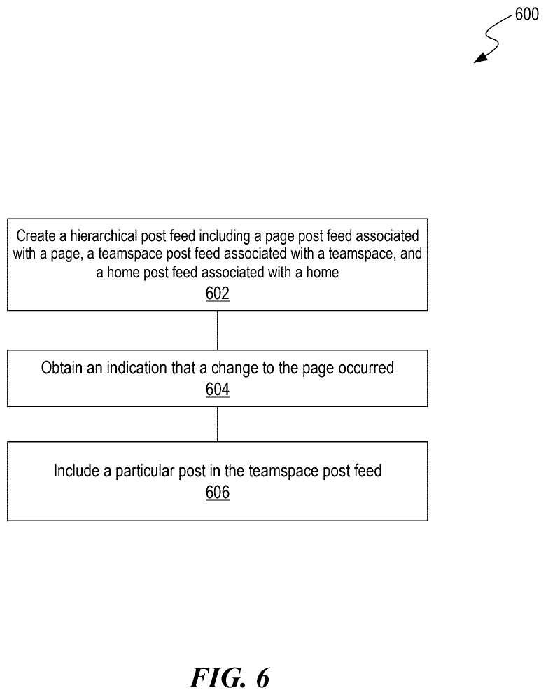

FIG. 6 is a flowchart of a method 600 to hierarchically organize post feeds. A hardware or software processor executing instructions described in this application can, in step 602, create a hierarchical post feed including a page post feed associated with a page, a teamspace post feed associated with a teamspace, and a home post feed associated with a home. The page post feed can include multiple posts associated with the page including a particular post. The particular post can include a change to the page. In some embodiments, the change to the page comprises creating a sub-page associated with the page or modifying an existing sub-page associated with the page. The teamspace can include multiple pages including the page. The teamspace post feed can include multiple posts associated with the multiple pages. The home can include multiple teamspaces including the teamspace. And the home post feed can include multiple teamspace post feeds including the teamspace post feed.

At step 604, the processor can obtain an indication that the change to the page occurred. Then, at step 606, the processor can include the particular post in the teamspace post feed. The particular post can include an identification of the change. The particular post can be presented as a tile in the teamspace post feed. The tile can be a preview of the particular post that includes the identification of the change. Including the particular post in the teamspace post feed can include the particular post in the home post feed.

In some embodiments, the processor can include the particular post in the teamspace post feed in reverse chronological order. In such embodiments, the reverse chronological order can be based on a time corresponding to obtaining the indication that the change to the page occurred relative to the multiple posts associated with the multiple pages of the teamspace post feed.

In some embodiments, in response to the change to the page, the processor can include the particular post in the page post feed. In such embodiments, upon including the particular post in the page post feed, the processor can obtain the indication that the change to the page occurred. Then, the processor can detect a cross post associated with the particular post. The cross post can comprise a selection, by a user, of the particular post and the teamspace post feed. In response to the cross post, the processor can include the particular post in the teamspace post feed.

In some embodiments, to include the particular post in the teamspace post feed, the processor generates a tile that includes an embedded link preview associated with the particular post. The embedded link preview can include a portion of the particular post associated with the change to the page. The embedded link preview can be expandable to view all of the particular post. The embedded link preview can include a link to the particular post in the page post feed. With the generated tile, the processor can insert the tile to the teamspace post feed.

In some embodiments, the teamspace post feed is a first teamspace post feed corresponding to a first teamspace of the multiple teamspaces. In such embodiments, the processor can determine that a user is not a member of the first teamspace. Then, the processor can obtain an opt-in indication from the user corresponding to the first teamspace post feed and include the first teamspace post feed in the home post feed.

In some embodiments, in response to including the particular post in the teamspace post feed, the processor can transmit the particular post to an artificial intelligence. The artificial intelligence can be configured to summarize the particular post. The processor can then generate, via the artificial intelligence, a summary of the particular post. The processor can include the summary of the particular post in the home post feed.

### Computer System

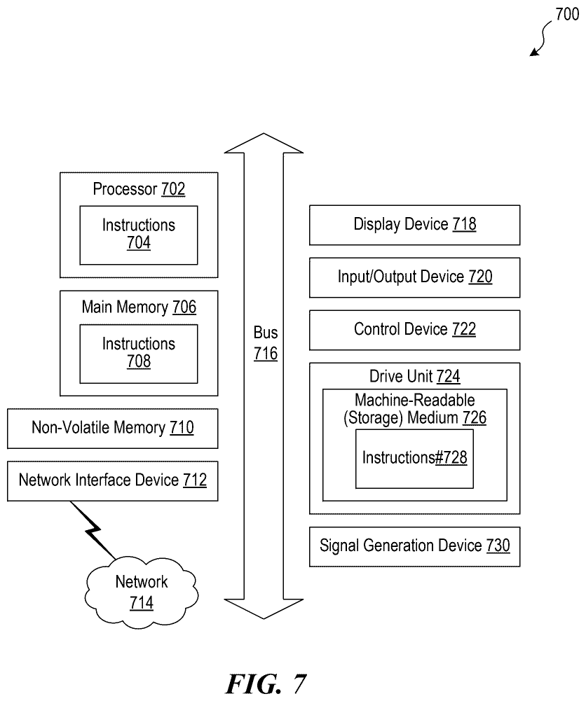

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 700. In some implementations, the computer system 700 can be an embedded computer system, a system-on-chip (SOC), a single-board computer (SBC) system, or a distributed system such as a mesh of computer systems or include one or more cloud components in one or more networks. Where appropriate, one or more computer systems 700 can perform operations in real time, near real time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising instructions recorded thereon, wherein the instructions, when executed by at least one data processor of a system, cause the system to:
create a hierarchical post feed including a page post feed associated with a page, a teamspace post feed associated with a teamspace, and a home post feed associated with a home,
wherein the page post feed includes multiple posts associated with the page including a particular post;
wherein the particular post includes a change to the page;
wherein the teamspace includes multiple pages including the page;
wherein the teamspace post feed includes multiple posts associated with the multiple pages;
wherein the home includes multiple teamspaces including the teamspace; and
wherein the home post feed includes multiple teamspace post feeds including the teamspace post feed;
obtain an indication that the change to the page occurred; and
include the particular post in the teamspace post feed,
wherein the particular post includes an identification of the change;
wherein the particular post is presented as a tile in the teamspace post feed;
wherein the tile is a preview of the particular post that includes the identification of the change; and
wherein including the particular post in the teamspace post feed includes the particular post in the home post feed.

2. The non-transitory, computer-readable storage medium of claim 1, wherein the change to the page comprises creating a sub-page associated with the page or modifying an existing sub-page associated with the page.

3. The non-transitory, computer-readable storage medium of claim 1, wherein the system is further caused to:
in response to the change to the page, include the particular post in the page post feed;
upon including the particular post in the page post feed, obtain the indication that the change to the page occurred;
detect a cross post associated with the particular post,
wherein the cross post comprises a selection, by a user, of the particular post and the teamspace post feed; and
in response to the cross post, include the particular post in the teamspace post feed.

4. The non-transitory, computer-readable storage medium of claim 1, wherein to include the particular post in the teamspace post feed, the system is further caused to:
generate the tile including an embedded link preview associated with the particular post,
wherein the embedded link preview includes a portion of the particular post associated with the change to the page;
wherein the embedded link preview is expandable to view all of the particular post;
wherein the embedded link preview includes a link to the particular post in the page post feed; and
insert the tile to the teamspace post feed.

5. The non-transitory, computer-readable storage medium of claim 1, wherein the system is further caused to:
include the particular post in the teamspace post feed in reverse chronological order,
wherein the reverse chronological order is based on a time corresponding to obtaining the indication that the change to the page occurred relative to the multiple posts associated with the multiple pages of the teamspace post feed.

6. The non-transitory, computer-readable storage medium of claim 1, wherein the teamspace post feed is a first teamspace post feed corresponding to a first teamspace of the multiple teamspaces, wherein the system is further caused to:
determine that a user is not a member of the first teamspace;
obtain an opt-in indication from the user corresponding to the first teamspace post feed; and
include the first teamspace post feed in the home post feed.

7. The non-transitory, computer-readable storage medium of claim 1, wherein the system is further caused to:
in response to including the particular post in the teamspace post feed, transmit the particular post to an artificial intelligence,
wherein the artificial intelligence is configured to summarize the particular post;
generate, via the artificial intelligence, a summary of the particular post; and
include the summary of the particular post in the home post feed.

8. A system comprising:
at least one hardware processor; and
at least one non-transitory memory storing instructions, which, when executed by the at least one hardware processor, cause the system to:
create a hierarchical post feed including a page post feed associated with a page, a teamspace post feed associated with a teamspace, and a home post feed associated with a home,
wherein the page post feed includes multiple posts associated with the page;
wherein the teamspace includes multiple pages including the page;
wherein the teamspace post feed includes multiple posts associated with the multiple pages;
wherein the home includes multiple teamspaces including the teamspace; and
wherein the home post feed includes multiple teamspace post feeds including the teamspace post feed;
obtain a particular post associated with the page at the page post feed; and
include the particular post in the teamspace post feed,
wherein the particular post is presented as a tile in the teamspace post feed;
wherein the tile is a preview of the particular post; and
wherein including the particular post in the teamspace post feed includes the particular post in the home post feed.

9. The system of claim 8, wherein the particular post comprises a new sub-page associated with the page or a modified existing sub-page associated with the page.

10. The system of claim 8, wherein the system is further caused to:
in response to a change to the page, transmit the particular post to the page post feed;
obtain the particular post at the page post feed;
detect a cross post associated with the particular post,
wherein the cross post comprises a selection, by a user, of the particular post and the teamspace post feed; and
in response to the cross post, include the particular post in the teamspace post feed.

11. The system of claim 8, wherein to include the particular post in the teamspace post feed, the system is further caused to:
generate the tile including an embedded link preview associated with the particular post,
wherein the embedded link preview includes a portion of the particular post associated with the page;
wherein the embedded link preview is expandable to view all of the particular post;
wherein the embedded link preview includes a link to the particular post in the page post feed; and
insert the tile to the teamspace post feed.

12. The system of claim 8, wherein the system is further caused to:
include the particular post in the teamspace post feed in reverse chronological order,
wherein the reverse chronological order is based on a time corresponding to obtaining the particular post associated with the page at the page post feed relative to the multiple posts associated with the multiple pages of the teamspace post feed.

13. The system of claim 8, wherein the teamspace post feed is a first teamspace post feed corresponding to a first teamspace of the multiple teamspaces, wherein the system is further caused to:
determine that a user is not a member of the first teamspace;
obtain an opt-in indication from the user corresponding to the first teamspace post feed; and
include the first teamspace post feed in the home post feed.

14. The system of claim 8, wherein the system is further caused to:
in response to including the particular post in the teamspace post feed, transmit the particular post to an artificial intelligence,
wherein the artificial intelligence is configured to summarize the particular post;
generate, via the artificial intelligence, a summary of the particular post; and
include the summary of the particular post in the home post feed.

15. A method comprising:
creating a hierarchical post feed including a page post feed associated with a page, a teamspace post feed associated with a teamspace, and a home post feed associated with a home,
wherein the page post feed includes multiple posts associated with the page including a particular post;
wherein the particular post includes a change to the page;
wherein the teamspace includes multiple pages including the page;
wherein the teamspace post feed includes multiple posts associated with the multiple pages;
wherein the home includes multiple teamspaces including the teamspace; and
wherein the home post feed includes multiple teamspace post feeds including the teamspace post feed;
obtaining an indication that the change to the page occurred;
including the particular post in the teamspace post feed,
wherein the particular post includes an identification of the change; and
in response to including the particular post in the teamspace post feed, including the particular post in the home post feed.

16. The method of claim 15, wherein the change to the page comprises creating a sub-page associated with the page or modifying an existing sub-page associated with the page.

17. The method of claim 15, further comprising:
in response to the change to the page, including the particular post in the page post feed;
upon including the particular post in the page post feed, obtaining the indication that the change to the page occurred;
detecting a cross post associated with the particular post,
wherein the cross post comprises a selection, by a user, of the particular post and the teamspace post feed; and
in response to the cross post, including the particular post in the teamspace post feed.

18. The method of claim 15, wherein including the particular post in the teamspace post feed further comprises:
generating a tile,
wherein the tile is a preview of the particular post that includes the identification of the change;
including, in the tile, an embedded link preview associated with the particular post,
wherein the embedded link preview includes a portion of the particular post associated with the change to the page;
wherein the embedded link preview is expandable to view all of the particular post;
wherein the embedded link preview includes a link to the particular post in the page post feed; and
inserting the tile to the teamspace post feed.

19. The method of claim 15, further comprising:
including the particular post in the teamspace post feed in reverse chronological order,
wherein the reverse chronological order is based on a time corresponding to obtaining the indication that the change to the page occurred relative to the multiple posts associated with the multiple pages of the teamspace post feed.

20. The method of claim 15, wherein the teamspace post feed is a first teamspace post feed corresponding to a first teamspace of the multiple teamspaces, further comprising:
determining that a user is not a member of the first teamspace;
obtaining an opt-in indication from the user corresponding to the first teamspace post feed; and
including the first teamspace post feed in the home post feed.
